(19) United States
(12) Patent Application Publication
(10) Pub. No.: US 2024/0251905 A1
(43) Pub. Date: Aug. 1, 2024

(54) SHOE, SOLE AND MANUFACTURING METHOD OF POLYMER MATERIAL

(71) Applicant: NAN YA PLASTICS CORPORATION, Taipei (TW)

(72) Inventors: Te-Chao Liao, Taipei (TW); Ching-Yao Yuan, Taipei (TW); Wei Tang Liao, Taipei (TW)

(73) Assignee: NAN YA PLASTICS CORPORATION, Taipei (TW)

(21) Appl. No.: 18/299,024

(22) Filed: Apr. 11, 2023

(30) Foreign Application Priority Data
Jan. 31, 2023 (TW) 112103271

(51) Int. Cl. A43B 1/14; A43B 1/00; A43B 13/04; C08G 63/16; C08J 9/00; C08J 11/24

(52) U.S. Cl. CPC A43B 1/14; A43B 1/0063; A43B 13/04; C08G 63/16; C08J 9/00; C08J 11/24; C08G 2410/00; C08J 2367/02

(57) ABSTRACT

A shoe, a sole and a manufacturing method of a polymer material are provided. The shoe includes a midsole, an outsole, an upper, a tongue, an insole and an adhesive. A material of the midsole, the outsole, the upper, the tongue, the insole and the adhesive are a polyester material.

### CROSS-REFERENCE TO RELATED APPLICATION

This application claims the priority benefit of Taiwan application Ser. No. 112103271, filed on Jan. 31, 2023. The entirety of the above-mentioned patent application is hereby incorporated by reference herein and made a part of this specification.

### BACKGROUND

### Technical Field

The invention relates to a shoe, a sole and a manufacturing method of a polymer material.

### Description of Related Art

Current shoes are made of a variety of materials, usually including nylon, polyester material, polyurethane, ethylene-vinyl acetate copolymer (EVA), synthetic rubber, textile fuel and other materials, wherein most of them are the materials which cannot be easily separated or recycled. Therefore, current shoes are difficult to be recycled and reused and are harmful to the environment.

### SUMMARY

The invention provides a shoe, a sole and a manufacturing method of a polymer material capable of effectively achieving environmental protection effect.

A shoe of the invention includes a midsole, an outsole, an upper, a tongue, an insole and an adhesive. A material of the midsole, the outsole, the upper, the tongue, the insole and the adhesive are a polyester material.

In an embodiment of the invention, a material of at least one of the midsole and the outsole is a recycled thermoplastic polyester elastomer (TPEE).

In an embodiment of the invention, a material of at least one of the upper, the tongue and the insole is a recycled polyester yarn.

In an embodiment of the invention, the shoe further includes a shoelace. A material of the shoelace is a polyester material.

In an embodiment of the invention, the shoe further includes a shoelace. A material of the shoelace is a recycled polyester yarn.

In an embodiment of the invention, the shoe is the whole pair of shoes to be recycled.

A manufacturing method of a polymer material of the invention includes: providing the shoe described above; performing an alcoholysis reaction of the shoe with a diol to form a polyester oligomer; and performing a polymerization reaction of the polyester oligomer and a polyalkylene glycol to obtain a thermoplastic polyester elastomer.

In an embodiment of the invention, the manufacturing method of a polymer material further includes: performing a foaming process on the thermoplastic polyester elastomer to obtain a foaming material.

In an embodiment of the invention, an antioxidant is used in at least one of the alcoholysis reaction and the polymerization reaction.

A sole of the invention is made of a thermoplastic polyester elastomer. The thermoplastic polyester elastomer is formed by the manufacturing method of a polymer material described above.

Based on the above, the material of the components included in the shoe of the invention is a polyester material. Thus, the shoe may be recycled by the manufacturing method of a polymer material, thereby achieving the effect of environmental protection. In addition, the thermoplastic polyester elastomer obtained by the manufacturing method of a polymer material may be further formed into a sole to achieve the effect of reuse.

To make the features and advantages of the disclosure to be comprehended more easily, embodiments are described in detail as follows.

### DESCRIPTION OF THE EMBODIMENTS

The following are embodiments describing the content of the invention in detail. The implementation details provided in the embodiments are for illustrative purposes, and are not intended to limit the scope of protection of the content of the invention. Those with ordinary knowledge in the art may modify or change these implementation details according to the needs of the actual implementation.

### Shoe

A shoe of the embodiment includes a midsole, an outsole, an upper, a tongue, an insole and an adhesive. In addition, the shoe of the invention may further include a shoelace or other components.

A material of the midsole and the outsole are a polyester material. The polyester material forming the midsole and the outsole may be the same or different. In this embodiment, a material of at least one of the midsole and the outsole is a recycled thermoplastic polyester elastomer, preferably both the material of the midsole and the outsole are a recycled thermoplastic polyester elastomer. The recycled thermoplastic polyester elastomer may be obtained by recycling an object or a waste material including polyethylene terephthalate (PET). For example, the object or the waste material including polyethylene terephthalate may include a plastic bottle, an industrial earring, a yarn or the like. The recycled thermoplastic polyester elastomer forming the midsole and the outsole may be the same or different.

A material of the upper, the tongue and the insole are a polyester material. The polyester material forming the upper, the tongue and the insole may be the same or different. In this embodiment, a material of at least one of the upper, the tongue and the insole is a recycled polyester yarn, preferably all of the material of the upper, the tongue and the insole are a recycled polyester yarn. The recycled polyester yarn may be obtained by recycling a plastic bottle. Specific examples of commercially available recycled polyester yarn may include SAYA (trade name, manufactured by Nan Ya Plastics Corporation) or other suitable recycled polyester yarns. The recycled polyester yarn forming the upper, the tongue and the insole may be the same or different.

A material of the adhesive is a polyester material, such as polyester glue. Specific examples of commercially available polyester glue may include A-9318PD (trade name, manufactured by Nan Ya Plastics Corporation) or other suitable polyester glues.

In this embodiment, the shoe may further include a shoelace. A material of the shoelace is a polyester material, such as recycled polyester yarn. The recycled polyester yarn forming the shoelace may be the same as or different from the recycled polyester yarn forming the upper, the tongue and the insole.

When all of the material of the components included in the shoe are polyester material, the shoe may be the whole pair of shoes to be recycled, thereby achieving the effect of environmental protection.

### Manufacturing Method of Polymer Material

A manufacturing method of a polymer material of the embodiment includes: providing the shoe described above; performing an alcoholysis reaction of the shoe with a diol to form a polyester oligomer; and performing a polymerization reaction of the polyester oligomer and a polyalkylene glycol to obtain a thermoplastic polyester elastomer.

The diol may include an aliphatic diol, preferably an aliphatic diol with 2 to 10 carbon atoms. For example, the diol may include ethylene glycol, 1,3-propanediol, 1,4-butanediol, a combination thereof or other suitable diols. A weight ratio of the shoe to the diol may be 1:0.5 to 1:3, such as 1:0.5, 1:1, 1:1.5, 1:2, 1:2.5, 1:3 or any ratio between 1:0.5 and 1:3.

The reaction condition of the alcoholysis reaction is not particularly limited, and suitable reaction condition may be selected according to needs. For example, the alcoholysis reaction may be performed at a temperature of 200° C. to 250° C., such as 200° C., 210° C., 220° C., 230° C., 240° C., 250° C. or any temperature between 200° C. and 250° C. The alcoholysis reaction may be performed at a pressure of 80 kPa to 130 kPa, such as 80 kPa, 90 kPa, 100 kPa, 110 kPa, 120 kPa, 130 kPa or any pressure between 80 kPa and 130 kPa. A reaction time of the alcoholysis reaction may be 150 minutes to 270 minutes, such as 150 minutes, 180 minutes, 210 minutes, 240 minutes, 270 minutes or any time between 150 minutes and 270 minutes.

In the alcoholysis reaction, an alcoholysis catalyst may be used. The alcoholysis catalyst may include a titanium compound, a tin compound, an antimony compound, a combination thereof or other suitable alcoholysis catalysts. For example, the titanium compound may include tetrabutyl titanate, titanyl oxalate salt or other suitable titanium compounds. The tin compound may include dibutyltin dilaurate, dioctyltin, tin oxide or other suitable tin compounds. The antimony compound may include antimony trioxide, antimony triacetate or other suitable antimony compounds. An added amount of the alcoholysis catalyst may be 50 ppm to 500 ppm, such as 50 ppm, 100 ppm, 150 ppm, 200 ppm, 250 ppm, 300 ppm, 400 ppm, 500 ppm, or any added amount between 50 ppm and 500 ppm.

The polyester oligomer may include bis 2-hydroxyethyl terephthalate (BHET) or other mid products. The polyester oligomer may be used as a hard segment of the thermoplastic polyester elastomer. For example, the polyester oligomer as a hard segment may account for 30 wt % to 80 wt % of the thermoplastic polyester elastomer, such as 30 wt %, 40 wt %, 50 wt %, 60 wt %, 70 wt %, 80 wt % or any weight ratio between 30 wt % and 80 wt %.

The polyalkylene glycol may include a long-chain polyalkylene glycol, such as polytetramethylene ether glycol. The polyalkylene glycol may be used as a soft segment of the thermoplastic polyester elastomer. For example, the polyalkylene glycol as a soft segment may account for 20 wt % to 70 wt % of the thermoplastic polyester elastomer, such as 20 wt %, 30 wt %, 40 wt %, 50 wt %, 60 wt %, 70 wt % or any weight ratio between 20 wt % to 70 wt %.

The reaction condition of the polymerization reaction is not particularly limited, and suitable reaction condition may be selected according to needs. For example, the polymerization reaction may be performed at a temperature of 230° C. to 280° C., such as 230° C., 240° C., 250° C., 260° C., 270° C., 280° C. or any temperature between 230° C. and 280° C. The polymerization reaction may be performed at a pressure of 0 kPa to 50 kPa, such as 0 kPa, 10 kPa, 20 kPa, 30 kPa, 40 kPa, 50 kPa or any pressure between 0 kPa and 50 kPa. A reaction time of the polymerization reaction may be 90 minutes to 270 minutes, such as 90 minutes, 120 minutes, 150 minutes, 180 minutes, 210 minutes, 240 minutes, 270 minutes or any time between 90 minutes and 270 minutes.

In the polymerization reaction, a polymerization catalyst may be used. The polymerization catalyst may include a titanium compound, a magnesium compound, a sodium compound, a phosphorus compound, a tin compound, an antimony compound, a combination thereof or other suitable polymerization catalysts. For example, the titanium compound may include tetrabutyl titanate, titanyl acetate salt or other suitable titanium compounds. The magnesium compound may include magnesium oxide, magnesium oxyacetate salt or other suitable magnesium compounds. The sodium compound may include sodium oxide, sodium oxyacetate salt or other suitable sodium compounds. The phosphorus compound may include phosphorus oxide, phosphate oxyacetate salt or other suitable sodium compounds. The tin compound may include dioctyltin, tin oxide or other suitable tin compounds. The antimony compound may include antimony trioxide, antimony triacetate or other suitable antimony compounds. An added amount of the polymerization catalyst may be 50 ppm to 1000 ppm, such as 50 ppm, 100 ppm, 300 ppm, 500 ppm, 700 ppm, 1000 ppm, or any added amount between 50 ppm and 1000 ppm.

In this embodiment, an antioxidant may be used in at least one of the alcoholysis reaction and the polymerization reaction. Thus, the color stability of the product may be further maintained. The antioxidant may include at least one of following material: tetrakis[(3,5-di-tert-butyl-4-hydroxyphenyl)propionic acid] pentaerythritol ester, tris(2,4-di-tert-butylphenyl) phosphite and octadecyl 3-(3,5-di-tert-butyl-4-hydroxyphenyl)propionate. An added amount of the antioxidant may be 100 ppm to 5000 ppm, such as 100 ppm, 300 ppm, 500 ppm, 800 ppm, 1000 ppm, 3000 ppm, 5000 ppm, or any added amount between 100 ppm and 5000 ppm.

In this embodiment, the manufacturing method of the polymer material may further include performing a foaming process on the thermoplastic polyester elastomer to obtain a foaming material. For example, additives such as a chain extender, an antioxidant, a flame retardant and a heat stabilizer are mixed with a thermoplastic polyester elastomer, and then a twin screw extruder is used to knead and obtain a foaming masterbatch. Next, the foaming masterbatch is mixed with supercritical fluid (such as nitrogen, carbon dioxide, etc.) through a supercritical fluid injection machine and injected to obtain a foaming material. The foaming material may have excellent properties such as light weight, high rigidity, high specific strength, good electrical insulation, good sound insulation and heat insulation. The foaming material prepared by the manufacturing method of the polymer material has a hardness of Shore 25 D to 45 D, a density of 0.15 to 0.3 g/cm³a tensile strength of 5 to 15 kgf/cm, and a resilience of 60% to 70%. Thus, the foaming material may be applied in the component of the shoe, such as a sole.

### Sole

A sole of the embodiment is made of a thermoplastic polyester elastomer, and the aforementioned thermoplastic polyester elastomer is formed by the manufacturing method of the polymer material described above. The sole may be used in the shoe described above.

For example, in the manufacturing method of the polymer material, the foaming masterbatch may be mixed with supercritical fluid (such as nitrogen, carbon dioxide, etc.) through a supercritical fluid injection machine and injected to obtain a sole. The sole may include a midsole and an outsole. When the sole including the midsole and the outsole is integrally formed by injection molding, an adhesive between the midsole and the outsole may be omitted.

Hereinafter, examples of the shoe, the sole and the manufacturing method of the polymer material of the invention are provided. However, those examples are illustrative, and the invention is not limited to the scope of those examples.

### Example

About 297 g of the shoe was crushed with a pulverizer (model: KM210, manufactured by Chang Woen Machinery Co., Ltd.). In about 297 g of the shoe, it included about 198 g of the sole (the midsole and the outsole), about 54 g of the upper, about 21 g of the tongue, about 14 g of the insole, about 5 g of the shoelace and about 5 g of the adhesive. The material of the sole was the recycled thermoplastic polyester elastomer, which was formed by the manufacturing method of the polymer material of the invention. The material of the upper, the tongue, the insole and the shoelace were the recycled polyester yarn (trade name: SAYA, manufactured by Nan Ya Plastics Corporation). The material of the adhesive was the polyester glue (trade name: A-9318PD, manufactured by Nan Ya Plastics Corporation).

Next, the crushed shoe was mixed with 450 g of an aliphatic diol, 200 ppm of tetrabutyl titanate and 200 ppm of antimony trioxide, and the alcoholysis reaction was performed at a temperature of 240° C. and a pressure of 110 kPa for 240 minutes to form about 300 g of the polyester oligomer. Then, 300 g of polytetramethylene ether glycol, 300 ppm of tetrabutyl titanate, 300 ppm of sodium oxyacetate salt, 500 ppm of tetrakis[(3,5-di-tert-butyl-4-hydroxyphenyl)propionic acid] pentaerythritol ester and 500 ppm of tris(2,4-di-tert-butylphenyl) phosphite were added thereto, and the polymerization reaction was performed at a temperature of 270° C. and a pressure of 5 kPa for 240 minutes to obtain about 550 g of the recycled thermoplastic polyester elastomer (recovery rate: about 20 to 70%).

Based on the above, all of the material of the components included in the shoe of the invention are a polyester material, so the shoe may be recycled by the manufacturing method of the polymer material to achieve the effect of environmental protection. In addition, the thermoplastic polyester elastomer obtained by the manufacturing method of the polymer material may further form a sole and the sole may be used in another shoe to achieve the effect of reuse.

What is claimed is:

1. A shoe, comprising:
a midsole, an outsole, an upper, a tongue, an insole and an adhesive,
wherein a material of the midsole, the outsole, the upper, the tongue, the insole and the adhesive are a polyester material.

2. The shoe according to claim 1, wherein a material of at least one of the midsole and the outsole is a recycled thermoplastic polyester elastomer.

3. The shoe according to claim 1, wherein a material of at least one of the upper, the tongue and the insole is a recycled polyester yarn.

4. The shoe according to claim 1, further comprising a shoelace, wherein a material of the shoelace is a polyester material.

5. The shoe according to claim 1, further comprising a shoelace, wherein a material of the shoelace is a recycled polyester yarn.

6. The shoe according to claim 1, being the whole pair of shoes to be recycled.

7. A manufacturing method of a polymer material, comprising:
providing the shoe according to claim 1;
performing an alcoholysis reaction of the shoe with a diol to form a polyester oligomer; and
performing a polymerization reaction of the polyester oligomer and a polyalkylene glycol to obtain a thermoplastic polyester elastomer.

8. The manufacturing method of a polymer material according to claim 7, further comprising:
performing a foaming process on the thermoplastic polyester elastomer to obtain a foaming material.

9. The manufacturing method of a polymer material according to claim 7, wherein an antioxidant is used in at least one of the alcoholysis reaction and the polymerization reaction.

10. A sole, a material thereof being a thermoplastic polyester elastomer,
wherein the thermoplastic polyester elastomer is formed by the manufacturing method of a polymer material according to claim 7.
